(19) United States
(12) Patent Application Publication
(10) Pub. No.: US 2016/0347024 A1
(43) Pub. Date: Dec. 1, 2016

(54) MATERIAL COMPOSITION FOR THE PRODUCTION OF A STIFFENING MEMBER FOR LIGHTWEIGHT CONSTRUCTION, METHOD FOR PRODUCING A STIFFENING MEMBER FOR LIGHTWEIGHT CONSTRUCTION AND STIFFENING MEMBER FOR LIGHTWEIGHT CONSTRUCTION

(71) Applicant: Carcoustics TechConsult GmbH, Leverkusen (DE)

(72) Inventors: Thorsten HORNICH, Gamprin (LI); Christoph NACHBAUR, Fraxern (AT)

(21) Appl. No.: 14/873,991

(22) Filed: Oct. 2, 2015

(30) Foreign Application Priority Data
May 26, 2015 (DE) 10 2015 108 221.7

(51) Int. Cl. B32B 3/12; B31F 1/00; B32B 29/00; B32B 29/08; B32B 3/28; B32B 7/12

(52) U.S. Cl. CPC B32B 3/12; B32B 3/28; B32B 7/12; B32B 29/005; B32B 29/08; B31F 1/0009; B32B 2307/56; B32B 2605/00; B31F 2201/00

(57) ABSTRACT

A material composite for the production of a stiffening member for lightweight construction by means of thermoforming includes a cellulose-based core made of a wavy paper web or having a honeycomb structure and a kraftliner, which is mechanically connected to the wavy paper web or the honeycomb structure and which in turn comprises a planar paper web. An adhesive layer is disposed between the planar paper web of the kraftliner and the core, which mechanically connects the planar paper web to the core. Furthermore, a stiffening member for lightweight construction is produced on the basis of the material composite and a production method suitable for this purpose.

### FIELD

The disclosure relates to a stiffening member for lightweight construction, in particular for vehicle construction, which is suitable for the mechanical reinforcement and/or damping of the vibration tendency of two-dimensional components. The disclosure further relates to a method for producing such a stiffening member.

### BACKGROUND

For example, a conventional method for damping the vibration of two-dimensional components, such as the roof panel of a motor vehicle, which is used in automobile engineering, is based on the application of an elastomeric heavy layer directly on the component of the vehicle body to be damped. For this purpose, a still-liquid elastomeric mass is applied to the component to be damped, for example by application through injection or extrusion. The applied layer is then cured/cross-linked.

Furthermore, it is known that the vibration tendency of two-dimensional components in automobile engineering can be reduced if a woven fiberglass mat is glued to the surface of the component. Under the name BETABRACE™, the company Dow Automotive (USA) sells a corresponding self-adhesive fiberglass mat, for example, which is intended specifically for this use. The composite component produced, which is made of a two-dimensional component, an adhesive layer and a fiberglass mat has a significantly modified vibration behavior both with respect to possible resonant frequencies as well as intrinsic vibration damping. Nevertheless, the effectiveness of such stiffening members when using thin fiberglass mats is not sufficient for all cases of application. Though the use of thicker fiberglass mats improves the effectiveness of the stiffening member, it causes a disadvantageous increase in the total weight of the stiffening member.

The stiffening members sold under the name “CC-Brace are based on a metal foil laminated with a pressure-activatable adhesive layer. These stiffening members are used analogously to the above-mentioned stiffening members BetaBrace™ Reinforcing Composite. However, the stiffening members of the type “CC-Brace” are also subject to the aforementioned limitations.

### SUMMARY

The disclosure relates to a novel stiffening member that avoids the aforementioned drawbacks. Furthermore, the disclosure relates to a material composite that is suitable for the production of such a stiffening member and an advantageous production method for such a stiffening member.

A material composite according to the disclosure is provided for the production of a stiffening member for lightweight construction by means of thermoforming. It comprises a cellulose-based core made of a wavy paper web or having a honey-comb structure and a kraftliner, which is provided for mechanical connection to the wavy paper web or the honeycomb structure and which in turn comprises a planar paper web. The planar paper web of the kraftliner typically has a weight per unit area of 100 g/m², preferably of more than 150 g/m², and particularly preferably of more than 200 g/m². According to the disclosure, a thermally activatable and thermosetting adhesive layer disposed between the planar paper web of the kraftliner and the core is provided, which is provided to mechanically connect, in the activated state, the planar paper web of the kraftliner to the core, in particular to the wavy paper web of the core.

A material composite according to the disclosure has particular advantages for thermoforming. Even in the hot state, the thermally activatable and thermosetting adhesive layer has a good mechanical load-bearing capacity, so that a thermoformed component produced using the material composite can be removed from the mold used for thermoforming even in the hot or only slightly cooled state without losing its three-dimensional contour produced by thermoforming. A cooling-off step, e.g. in the opened molding tool, for waiting for the produced component to cool off sufficiently, which reduces the cycle times, is therefore unnecessary. Furthermore, the component produced is very light and, nevertheless, can have a high level of mechanical stability. Furthermore, a two-dimensional component produced in this manner has a very high vibration resistance perpendicular to its surface. This applies particularly if the core comprises a wavy paper web and if the wavy structure extends in a plane orientated parallel to the planar paper web of the kraftliner. For this purpose, the “crests” or “troughs” of the wavy structure can be directly connected to the planar paper web of the kraftliner by means of the adhesive layer. However, even if the wavy paper web is oriented differently or if a core is used that comprises a honeycomb structure, high vibration resistances transverse to the extension plane are achievable.

A stiffening member according to the disclosure for lightweight construction that can be produced by means of a thermoforming process, for example, using a material composite according to the disclosure comprises a cellulose-based core made of a wavy paper web or having a honeycomb structure and a kraftliner, which is mechanically connected to the wavy paper web or the honeycomb structure and which in turn comprises a planar paper web. According to the disclosure, it is provided that the planar paper web of the kraftliner is mechanically connected to the core by means of a thermally cured, thermosetting adhesive layer, for example.

In this case, the stiffening member realizes, in particular, the above-mentioned advantages with respect to it being producible by means of thermoforming and with respect to lightness and vibration resistance. Therefore, it is eminently suitable for damping even larger, two-dimensionally extending components which often have an increased tendency for transverse vibrations. Thus, it is particularly suitable for use in vehicle body manufacturing, e.g. for stiffening the roof area of a motor vehicle.

A stiffening member according to the disclosure can not only have a permanent three-dimensional contour, rather, it can also have regions in which the material thickness of the material composite is specifically locally reduced, e.g. in the form of a sealing peripheral edge, which, due to its increased mechanical strength, is also well suited for attaching the component e.g. to the vehicle body of a motor vehicle, e.g. to a roof panel. Furthermore, local regions with a reduced material thickness can be specifically formed in the surface of a three-dimensionally contoured stiffening member where an increased mechanical load-bearing capacity is required, e.g. at mounting points, through-holes for pulling through lines of all kinds, or also for stamping stiffening ribs, e.g. for reducing the vibration tendency of the component itself.

In a preferred embodiment, the core of a material composite or stiffening member according to the disclosure comprises at least two wavy and one planar paper web, which are glued together to form a corrugated cardboard, with the planar paper web being disposed between the wavy paper webs. However, the use of an even higher number of, for example, three, four or more wavy paper webs with one planar paper web, respectively, being disposed between them, is also conceivable. In this case, irrespective of the number of the wavy paper webs provided, it has proved to be particularly advantageous with regard to processibility in a thermoforming method if the paper webs of the corrugated cardboard are connected by means of thermally stable adhesive layers, preferably by means of cured thermosetting adhesive layers.

In another advantageous embodiment of a material composite or stiffening member according to the disclosure, at least the planar paper web of the kraft-liner is additionally fiber-reinforced, e.g. with glass fibers, carbon fibers, aramid fibers and/or natural fibers such as, for example, fibers of cotton, flax, hemp, jute, keraf, sisal or pulp. This results in a particularly high tensile strength of a component or the stiffening member, which was produced using the material composite, in its extension plane. However, the use of a fiber-reinforced core has also proved advantageous.

In another advantageous embodiment, which is characterized by an even more improved vibration resistance, the planar paper web of the kraftliner in the material composite or stiffening member according to the disclosure comprises a filler increasing the area density of the paper web. In this case, the use of BaSO₄, for example, has proved to be particularly suitable.

Furthermore, it has proved to be advantageous, for instance for decorative purposes, if the kraftliner of the material composite or stiffening member according to the disclosure comprises a thermoplastic cover layer, e.g. of polypropylene, polycarbonate, polyamide, acrylo-nitrile-butadiene-styrene, but also polyethylene, polyethylene terephthalate, polybutylene terephthalate, thermoplastic polyurethane, polyacetal, polyphenylene sulfide, cyclic olefin copolymer, thermotropic polyester and mixtures thereof. In this case, the thermoplastic cover layer in the material composite can also be formed as a separate layer, which connects mechanically with the kraftliner in a thermoforming process. In this case, the thermoplastic cover layer is disposed on the outside of the material composite or stiffening member and thus forms a decorative surface, which can be colored in a visually attractive manner and/or patterned in this manner. By surface-fusing the thermoplastic material in the thermoforming process, a direct connection between the thermoplastic cover layer and the kraftliner occurs in the process in the heated press.

If a thermoplastic cover layer is further combined with an outer textile layer made, for example, of a non-woven fabric, then the thermoplastic layer can also be provided as a thermally activatable adhesive layer for connecting the component formed in a thermoforming process with the textile layer. In such a case, the thermoplastic layer may be made, in particular, of a thin thermoplastic film or also of a layer of a hot-melt adhesive powder that has been sprinkled on, for example.

In another advantageous embodiment, the material composite according to the disclosure or the stiffening member according to the disclosure comprises two kraftliners mechanically connected to the core, which in turn each comprise a planar paper web, wherein the core is disposed between the paper webs of the kraftliners and is connected to them in each case by means of a thermally cured thermosetting adhesive layer. It is pointed out that, in the case of the material composite, the mechanical connection via the cured adhesive layer may possibly form only in a component produced from the material composite by means of thermoforming, and is not present yet in the material composite itself.

Special advantages with respect to the practical handling properties of a stiffening member according to the disclosure result if the stiffening member further has a pressure-activatable adhesive layer, which can be disposed, for example, on the side of the stiffening member facing away from the kraftliner. However, an arrangement on the outer surface of the kraftliner may also be advantageous. In these embodiments, the stiffening member can be mounted, e.g. within the context of the vehicle production, by simply pressing the component against the component to be stiffened, e.g. the roof area of a vehicle body. Due to its low weight, even large-surface stiffening members can be handled with ease by the assembly personnel without any support from machines.

A method according to the disclosure serves for producing a stiffening member for lightweight construction. It comprises at least the following method steps:
1) providing a material composite with the following components:
   a) a cellulose-based core made of a wavy paper web or having a honey-comb structure,
   b) a kraftliner, which is mechanically connected to the wavy paper web or the honeycomb structure and which comprises a planar paper web, and
   c) a thermally curable adhesive layer, which is thermosetting in the cured state and which is disposed between the core and the paper web,
2) inserting the material composite into the cavity of a heated molding tool, and
3) thermoforming the material composite while thermally curing the adhesive layer, in such a way that the latter mechanically connects the core and the kraftliner with each other.

In particular, the method according to the disclosure permits the production of a stiffening member according to the disclosure, which may also correspond to one or more of the above-described advantageous embodiments, from a material composite according to the disclosure, for example, which may also correspond to one or more of the above-described advantageous embodiments. This permits the realization of high cycle numbers, because an additional retention time of the produced thermoformed component in the molding tool is no longer necessary due to its high dimensional stability also in a hot state. In another method step, the hot thermoformed material composite may optionally also be conveyed to a cooling-off station, in which the thermoformed material composite remains until its temperature has dropped to a predetermined intended temperature.

In an advantageous embodiment of the method according to the disclosure, the thermoformed material composite is cut in a further method step. This can take place, in particular, in the molding tool itself. For this purpose, the molding tool may have suitable integrated cutting, stamping or pinching tools.

In a particularly advantageous embodiment of the method according to the disclosure, the surface of the thermoformed material composite facing away from the kraftliner, for example, is provided with a pressure-activatable adhesive layer in another method step, which can be covered with a removable liner. This produces a stiffening member that can be attached manually or in an automated manner by simply pressing it against the component to be damped. Optionally, the pressure-activatable adhesive layer may also be disposed on the outer surface of the kraftliner.

Within the context of the method according to the disclosure, the material composite placed into the cavity of the molding tool can not only be given a permanent three-dimensional contour, but it is also possible to specifically reduce the material thickness of the material composite locally, e.g. in order to produce a sealing peripheral edge, which, due to its increased mechanical strength, is also well suited for attaching the component e.g. to the vehicle body of a motor vehicle, e.g. to a roof panel. Furthermore, it is also possible to locally introduce regions with a reduced material thickness in the surface of the three-dimensionally contoured stiffening member where an increased mechanical load-bearing capacity is required, e.g. at mounting points, through-holes for pulling through lines of all kinds, or also for stamping stiffening ribs, e.g. for reducing the vibration tendency of the component itself.

Other advantages and features of the material composite according to the disclosure, of the stiffening member according to the disclosure and its possible use, and of a method provided for producing an advantageous stiffening member are apparent from the exemplary embodiments discussed below. They are not to be understood to be limiting, but are to serve for illustrating the present disclosure to the person skilled in the art.

Reference is made to the fact that all the features of the above-described advantageous embodiments and developments of the material composite according to the disclosure, of the stiffening member and of the production method can be freely combined with one another within the context of what is technically feasible, without this having to be explicitly mentioned in the present description of the disclosure. This also applies to the features of the exemplary embodiments described below, which will be explained in more detail with reference to the drawing.

### BRIEF DESCRIPTION OF THE DRAWINGS

FIG. 1: shows a schematic representation of a section through a material composite according to the disclosure,

FIG. 2: shows a schematic representation of a method for producing a material composite according to the disclosure,

FIGS. 3-4: show a schematic representation of a production method according to the disclosure for a stiffening member according to the disclosure,

FIG. 5: shows the stiffening member according to the disclosure produced in accordance with the method according to FIGS. 3 and 4,

FIG. 6: shows a second exemplary embodiment of a stiffening member according to the disclosure, and

FIG. 7: shows a schematic representation of a section through another material composite according to the disclosure.

### DETAILED DESCRIPTION OF THE DRAWINGS

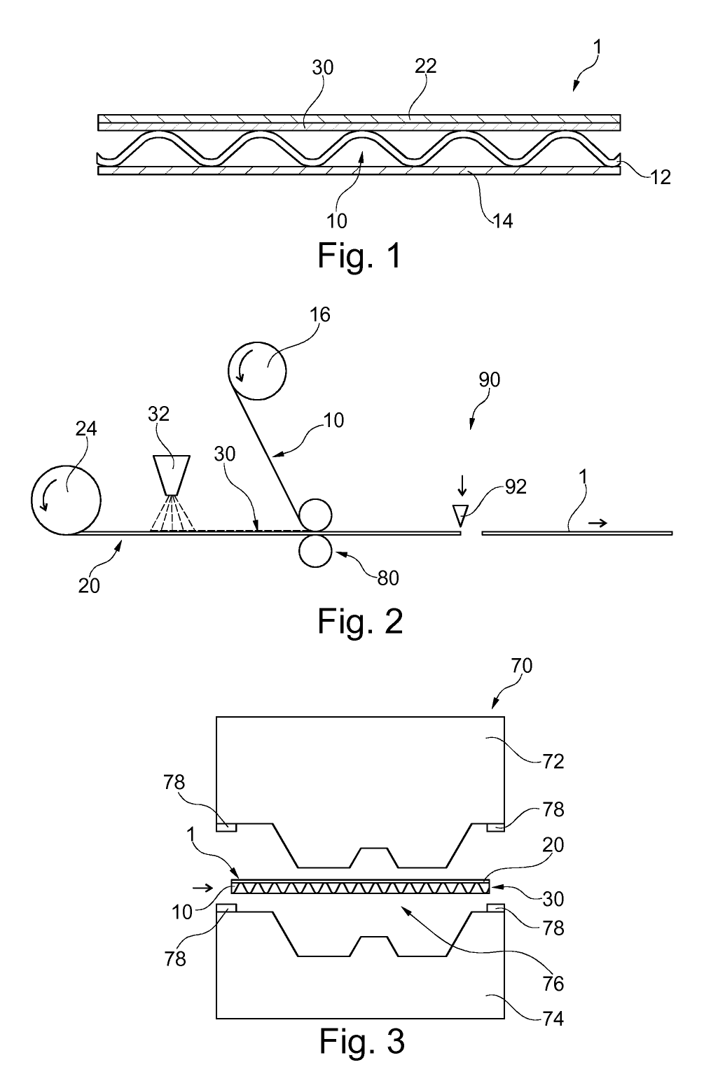

FIG. 1 shows a schematic representation of a section through a material composite 1 according to the disclosure, which comprises a cellulose-based core 10 made of a wavy paper web 12, which is glued to an also cellulose-based planar paper web 14 to form a corrugated cardboard. The wavy structure in this case extends in the plane of the planar paper web 14. The adhesive connection between the planar paper web 12 and the wavy paper web 14 is done in such a way that it withstands the temperatures in the hot molding tool during the subsequent thermoforming process. For example, the use of a thermosetting glue has proved its worth for this purpose.

Furthermore, the material composite 1 comprises a kraftliner 20, which is mechanically connected to the wavy paper web 12 and which, in the exemplary embodiment shown, is made of a planar paper web 22.

The kraftliner is coated with a thermally curable adhesive layer 30, which is thermosetting in the cured state and which is disposed between the core 10 and the paper web 22 in the material composite 1. The adhesive layer 30 can be based, for example, on a thermally cross-linkable polyurethane foam sprayed onto the surface of the planar paper web 22. Even in the non-cured state, the adhesive layer 30 effects an adhesion of the planar paper web 22 of the kraftliner 20 to the wavy paper web 12 of the core 10.

The planar paper web 22 of the kraftliner is also based on cellulose and has a weight per unit area of about 200 g/square meter. The thickness of the planar paper web 22 is about 0.5 mm. Barium sulfate has been added to the cellulose material of the planar paper web 22 in order to reach the specified weight per unit area at the specified material thickness.

Bother planar paper webs 14, 22 are reinforced with natural fibers of pulp.

FIG. 7 shows a second exemplary embodiment of a material composite 1 according to the disclosure, whose structure substantially matches that of the material composite 1 according to FIG. 1, wherein, however, the core 10 comprises two wavy paper webs 12 and one planar paper web 14, which are glued together to form a corrugated cardboard, with the planar paper web 14 being disposed between the wavy paper webs 12. The wavy paper webs 12 of the corrugated cardboard are connected to the planar paper web 14 by means of thermally stable adhesive layers 18 that may be made, for example, of a cured thermosetting polymer-based adhesive. The use of such a core for producing a stiffening member according to the disclosure has proved its worth in practice.

A method suitable for producing a material composite 1 according to the disclosure is shown schematically in FIG. 2. The planar paper web 22 forming the kraftliner 20 is reeled off from a supply reel 24 and guided past a spray nozzle 32. A thermally cross-linkable polyurethane foam is sprayed onto the surface of the top side of the planar paper web 22 by means of this nozzle 32. Then, the planar paper web 22 of the kraftliner 20, which is now coated with a thermally thermosetting curable adhesive layer 30, is conveyed to a laminating station 80 in which the kraftliner 20 coated with the adhesive layer 30 is brought together with the core 10, which is also reeled onto a supply reel 16 and which is configured as a corrugated cardboard according to FIG. 1. In the process, a sufficient pressure is exerted on the material composite 1 that is being produced, so that the result is a certain adhesion of the planar paper web 20 of the kraftliner 20 to the wavy paper web 12 of the core 10 due to the thermally curable adhesive layer 30, which is thermosetting in the cured state. Then, the material composite 1 produced in this way is conveyed to a cutting station 90 in which suitable material sections of the material composite 1 are cut to size for further processing by means of a cutting tool 92.

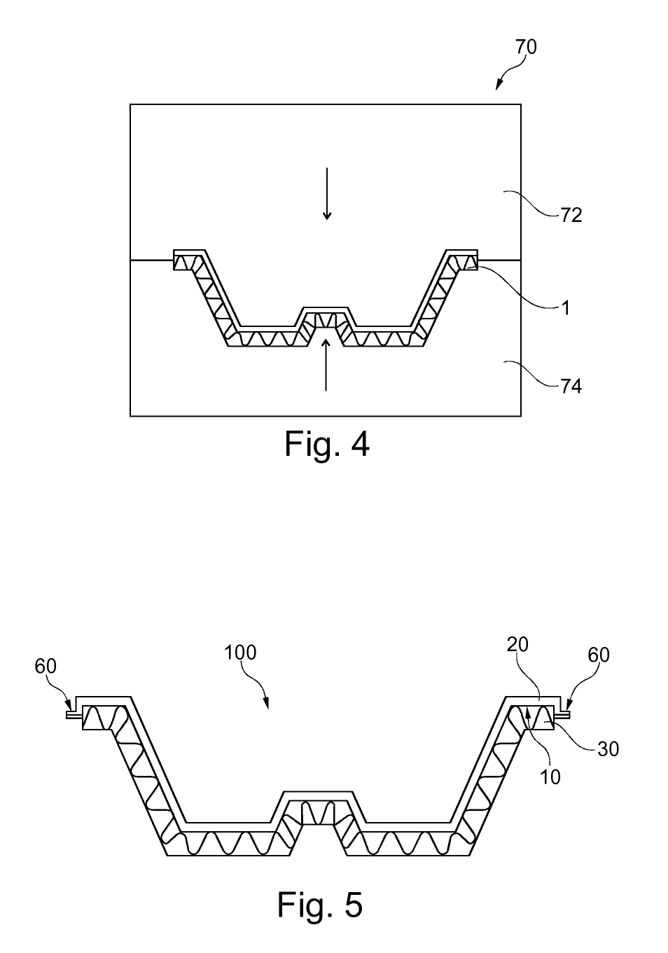

Sections of the material composite 1 according to the disclosure that have been cut to size are provided for the production of stiffening members 100 according to the disclosure in accordance with the inventive method. The cut-to-size sections of the material composite 1 comprising the kraftliner 20, the adhesive layer 30 and the core 10 are then conveyed to a thermoforming process, which is schematically explained with reference to the FIGS. 3 to 4.

The thermoforming process schematically shown in the FIGS. 3 and 4 for forming a stiffening member 100 according to the disclosure based on a material composite 1 according to FIG. 1 is carried out by means of a molding tool 70 whose two mold halves 72, 74 are configured to be heated. The tool temperature is set to about 180° for the thermoforming process, with the tool temperature being substantially determined by the activation temperature of the adhesive layer 30. The sections of the material composite 1 that were cut to size are placed in the opened cavity 76 of the molding tool 70 (see FIG. 3), whereupon the molding tool 34 is closed, as shown in FIG. 4. A suitable closing force is applied to the molding tool 34, which is then kept closed for a suitable period of time, which is typically between 20 and 200 seconds. The temperature in the molding tool and the closed time of the molding tool 70 are set in such a way that the adhesive layer 30 is thermally activated and cures in a thermosetting manner, connecting the core 10 to the kraftliner 20 in the process.

As a consequence, the material composite 1 follows the three-dimensional contour shaped by the molding tool 70. At the same time, the adhesive layer 30, which has completed its reaction, fixates the mold-shaped material composite 12 in the shaped form because it now has thermosetting properties. The stiffening member 100, which is being produced in this manner and is optionally provided with a three-dimensional contour, therefore retains its shaped form when it is removed from the molding tool 70 in the hot state. It is thus possible to realize fast cycle times in the thermoforming process.

In a preferred embodiment, which, however, is not shown here, individual or several outer or also inner surfaces of the core are additionally coated with thermally curable material, preferably material that cures in a thermosetting manner, e.g. a melamine resin or a polyurethane foam. These layers also cure in the thermoforming tool and provide the produced stiffening member with an additional dimensional stability, particularly in the hot state.

Then, the molding tool 70 is opened (not shown), and the stiffening member 100, which is now provided with a three-dimensional contour and is still hot, is removed from the molding tool 70 without cooling off. Finally, the three-dimensionally contoured stiffening member 100 schematically in a sectional view in FIG. 5 is conveyed to a cutting station (not shown) in which a peripheral cutting process is performed. Optionally, holes are punched out subsequently or in parallel, e.g. in order to form assembly openings in the stiffening member 100.

An advanced way of carrying out the process provides that the molding tool 70 is additionally provided with cutting or, optionally, punching tools in order to realize a cutting of the produced stiffening member 100 and the placement of possibly desired punched-out holes in parallel with the thermoforming process. However, this is not shown in the FIGS. 3 and 4.

In contrast, it is apparent from FIGS. 3 and 4 that the mold halves 72, 74 of the molding tool 70 are provided with embossing edges 78 that serve for providing the edge of the material composite 1 inserted into the cavity 76 with a peripheral embossed edge 60 in which the material thickness of the stiffening member 100 produced is significantly reduced. Preferably, the material thickness in this region is reduced to the extent that the core 10 has substantially no air-filled chambers anymore.

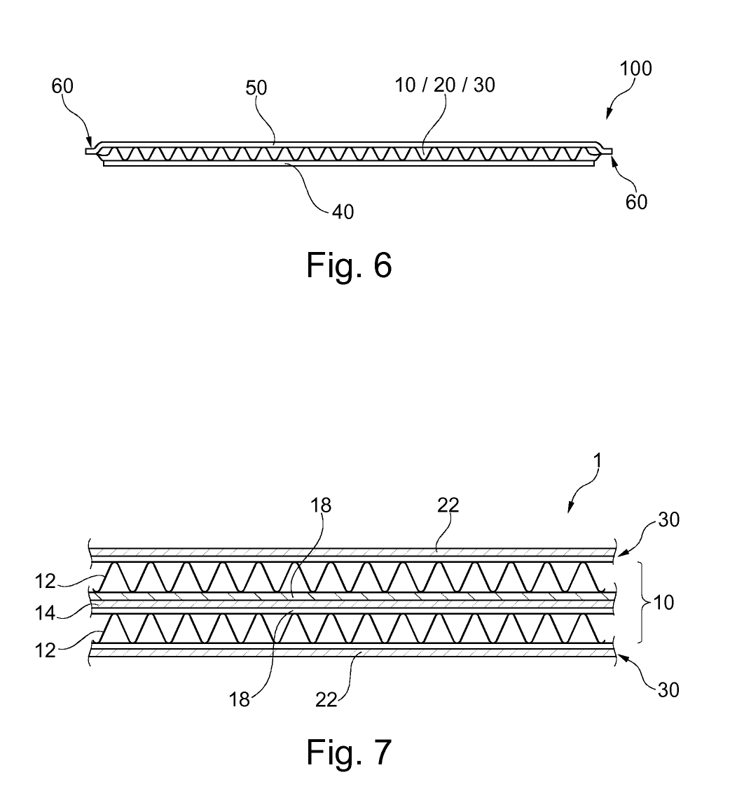

Finally, FIG. 6 shows a second exemplary embodiment of a stiffening member 100 according to the disclosure, which, in contrast to the first exemplary embodiment according to FIG. 5, is configured to be substantially planar. The structure of the stiffening member 100 according to this second exemplary embodiment matches that of the first exemplary embodiment except for the fact that the upper surface of the stiffening member 100 is coated with a decorative layer 50 made of a polyethylene film having a thickness of 50 micrometers. The latter is preferably also conveyed to the cavity 76 of the molding tool 70 during the production of the stiffening member 100, possibly by being reeled off from a supply reel (not shown). In the closed molding tool 70, the thermoplastic decorative layer 50 melts and connects to the adjacent surface of the material composite 1. A variety of surface patterns and qualities can be realized by varying the decorative layer 50 with respect to the material, material thickness, properties of the material, color, etc.

On the underside, the stiffening member 100 according to the second exemplary embodiment is provided with a pressure-activatable adhesive layer 40, which is covered with a liner (not shown). By means of the adhesive layer 40, the stiffening member 100 can be attached on the spot to the component to be stiffened, e.g. the roof panel of a motor vehicle, by simply being pressed on mechanically, the result being a two-dimensional mechanical connection between the stiffening member 100 and the component to be stiffened. The pressure-activatable adhesive layer 40 is preferably attached to the already thermoformed and sufficiently cooled-off stiffening member 100.

1. A material composite for the production of a stiffening member for lightweight construction by means of thermoforming, comprising:
a. a cellulose-based core made of a wavy paper web or having a honeycomb structure,
b. a kraftliner, which is mechanically connected to the wavy paper web or the honeycomb structure and includes a planar paper web,
wherein
c. a thermally activatable and thermosetting adhesive layer disposed between the planar paper web of the kraftliner and the core, is the adhesive layer being provided to mechanically connect, in an activated state, the planar paper web to the core.

2. A stiffening member for lightweight construction, comprising:
a. a cellulose-based core made of a wavy paper web or having a honeycomb structure,
b. a kraftliner, which is mechanically connected to the wavy paper web or the honeycomb structure and includes a planar paper web,
wherein
c. the planar paper web is mechanically connected to the core by means of a thermally cured, thermosetting adhesive layer.

3. The material composite according to claim 1 wherein the core comprises at least one wavy and one planar paper web, which are glued together to form a corrugated cardboard.

4. The material composite according to claim 1, wherein the wavy paper web and the planar paper webs of the corrugated cardboard are connected by means of cured, thermosetting adhesive layers.

5. The material composite according to claim 1, wherein the planar paper web of the kraftliner is fiber-reinforced.

6. The material composite according to claim 1, wherein the planar paper web of the kraftliner comprises a filler that increases the area density of the paper web.

7. The material composite according to claim 1, wherein the core is fiber-reinforced.

8. The material composite according to claim 1 wherein the kraftliner comprises a thermoplastic cover layer.

9. The material composite according to claim 1 wherein the material composite the stiffening member comprises two kraftliners, which in turn each comprise a planar paper web, wherein the core is disposed between the paper webs of the kraftliners and is connected to them in each case by means of a thermally cured, thermosetting adhesive layer.

10. The stiffening member according to claim 2, wherein it has a pressure-activatable adhesive layer disposed on the side of the stiffening member facing away from the kraftliner.

11. Use of a stiffening member according to claim 2 in vehicle body manufacture for reinforcement and/or vibration damping of two-dimensional components.

12. A method for producing a stiffening member for lightweight construction, including the following method steps:
a. providing a material composite having:
i. a cellulose-based core made of a wavy paper web or having a honeycomb structure,
ii. a kraftliner, which is mechanically connected to the wavy paper web or the honeycomb structure and which comprises a planar paper web,
iii. a thermally curable adhesive layer, which is thermosetting in the cured state and which is disposed between the core and the paper web of the kraftliner,
b. inserting the material composite into the cavity of a heated molding tool,
c. thermoforming the material composite while thermally curing the adhesive layer, in such a way that the latter mechanically connects the core and the kraftliner with each other.

13. The method according to claim 12, wherein the thermoformed material composite is cut in a further method step.

14. The method according to claim 13, wherein the cutting takes place in the molding tool.

15. The method according to claim 12, wherein, the thermoformed material composite is conveyed to a cooling-off station, where the thermoformed material composite remains until its temperature has dropped to a predetermined intended temperature.

16. The method according to claim 12, wherein the provided material composite comprises:
a cellulose-based core made of a wavy paper web or having a honeycomb structure,
a kraftliner, which is mechanically connected to the wavy paper web or the honeycomb structure and includes a planar paper web,
wherein a thermally activatable and thermosetting adhesive layer disposed between the planar paper web of the kraftliner and the core, is the adhesive layer being provided to mechanically connect, in an activated state, the planar paper web to the core, wherein the core includes at least one wavy and one planar paper web, which are glued together to form a corrugated cardboard.

17. The method according to claim 12, wherein the surface of the stiffening member facing away from the kraftliner is provided with a pressure-activatable adhesive layer.
